(19) United States
(12) Patent Application Publication
(10) Pub. No.: US 2003/0090723 A1
(43) Pub. Date: May 15, 2003

(54) Method and device for producing a printing pattern

(76) Inventors: Herwart Schmidt-Joos, Berlin (DE); Marcel Peter Weiher, Berlin (DE); Ralph Zuhlsdorf, Kleinmachnow (DE)

Correspondence Address: Womble Carlyle Sandridge & Rice, PLLC, P.O. Box 7037, Atlanta, GA, 30357-0037, US

(21) Appl. No.: 10/219,678

(22) Filed: Aug. 14, 2002

Related U.S. Application Data
(63) Continuation of application No. PCT/DE01/01051, filed on Mar. 19, 2001.

(30) Foreign Application Priority Data
Mar. 17, 2000 (DE) 100 13 096.8

(51) Int. Cl. G06K 1/00; G06F 15/00

(52) U.S. Cl. 358/1.18

(57) ABSTRACT

The invention relates to a method and a device and an intelligent document format for producing and processing publication documents, preferably in a telecontrolled manner. A graphically unstructured document pattern is analyzed according to logical components which can be parameterized and optionally replaced by substitution elements. The course of manufacture of classic publication production can thus be tremendously simplified and made more cost-effective.

### CROSS-REFERENCE TO RELATED APPLICATIONS

This application is a continuation of PCT application no. PCT/DE01/01051 (designating the U.S.), filed on Mar. 19, 2001, which claims priority on German patent application number 100 13 096.8, filed on Mar. 17, 2000. The specification and drawing of the mentioned PCT application and the mentioned German patent application are specifically incorporated herein by this reference

### FIELD OF THE INVENTION

The present invention relates to a method for processing and producing electronic publication documents and to the appropriate device for that. For the publication documents, there is no restriction on the later use purpose thereof. Especially there are printing patterns such as advertisements of the newspaper and magazine field, but also publication documents for presenting on any electronic visual display devices.

### DESCRIPTION OF THE PRIOR ART

The repetitive process that has an effect on the layout in publication documents by content alterations is expensive and therefore cost and time-intensive. Additionally, very often quality losses by unintended layout alterations or even the destruction of the design are associated with each content alteration.

Even simple content alterations can only be effected by experts like graphic artists, fair draughtsmen or DTP pros, which have to be trained to complicated graphics programs. This circumstance ties creativity potential and wastes working time for unnecessary automatable tasks.

In content alterations in publication documents by laymen, currently the danger of destruction of the unitary corporate design exists. The main reason for this is that today's publication documents don't contain any intelligence excluding destruction of the underlying design in case of manual intervention.

The object of the invention is to avoid the described disadvantages in the prior art and to propose a method, a device as well as an “intelligent” document format and a computer program for telecontrolled production and processing of publication documents. Apart from the separation of content and design, in content adaptations, by the rules contained in these intelligent publication documents it is assured that unwanted design alterations cannot arise.

The economical inventive purpose is in the cost and time saving, economical benefit over the flows comparable to the prior art of today. In consequent use of the invention, it is to be expected that the production flow in the classic publication production will be greatly simplified and provide new more effective work conditions.

### SUMMARY OF THE INVENTION

According to the invention, the object is solved by a method according to claim 1 and a device according to claim 10. Advantageous developments are apparent from the dependent claims.

The invention can be realized as a software system for the control of the underlying template technology, wherein the software system comprises: a means for producing and processing the templates on a remote computer system (server), wherein the template production/processing is effected on the server and is manipulated in telecontrolled manner via a local web browser as today is used in the Internet as default; a means for producing and processing the templates on a local computer is an additional possibility of producing and processing the templates even without server; a means that allows to effect content changes in publication documents on a server computer system in telecontrolled manner and subsequently to newly combine design and content in the templates, wherein the telecontrolled input dialog on the one hand can be effected via a standard web browser which is provided with a preview of the altered publication document for the respective initiating browser dialog for input control, and on the other hand is automatically provided with new contents via so-called batch interfaces to foreign processes.

For example, the invention allows for the difficult task, within the bounds of the corporate design guidelines of a mark or campaign, respectively, of producing an attractive advertisement, which is reduced to the much simpler task for the end user to select between variants. Thereby, the entire task has not become easier, but it allows dealing with the complex part once for all of the succeeding processes. It is not the kernel that decides how the division is precisely constituted, but the “intelligent” templates used with the kernel.

For example, the invention can be used in order that local advertising institutions (e.g. trading partners, registered offices, any persons) can effect content alterations via the Internet with centrally preset design patterns with preservation of a preset quality standard without thereby destroying the design.

Application Case with Respect to the Example “Advertisement Localization”

An agency engaged by the mark owner e.g. produces an advertisement corresponding to its defined corporate design. This advertisement serves as a pattern advertisement. The invention allows to the local advertising institution to modify or to exchange individual “permitted” text and picture elements via the Internet with preservation of all of the features relevant to the corporate design. The adaptation of the pattern advertisement can be independently effected by the local advertising institutions in a user-friendly browser window. The incorporation of regional agencies is dropped.

The centrally produced pattern advertisement and the advertisement elements to be adapted are read into a computer program for further processing. This pattern advertisement and its substitution elements are e.g. produced by layout experts in an advertising agency with standard publishing programs and e.g. made available as an EPS file. Thereby, a straightforward adaptation to the existing software environment is assured. Both the advertisement pattern and the advertisement elements available for the parties to a contract for the modification of their local advertisement, can be produced in usual manner.

The mark owner and the engaged agency centrally determine with the corporate design defaults, which advertisement elements are to be fixed and which advertisement elements are to be variable. In addition, the substitution elements are defined.

The adaptation of the advertisement is effected by the parties to a contract in a browser window. A computer program on a remote computer (server) connected to the computer (client) of the party to a contract via the Internet, realizes the integration of the modified advertisement elements with exactly accounting for the defined corporate design.

As a result, unitary advertisements result, which have all of the significant features of the preset corporate design and contain the adapted elements of the respective parties to a contract. The central marketing management experiences a substantial increase in efficiency since by this method the corporate design defaults are assured systematically. Agreements with local agencies are dropped.

Template Technology

The template technology allows for the separation of design and content by parameterized printing patterns, and thereby for substantial increases in efficiency in the processing of design in publishing documents. Design and content can be respectively separately produced and reused. The so far usual repeat of expensive, cost intensive processes and error-prone manual working steps in content alterations is dropped.

The template technology is based on basic mechanisms of informatics, which are combined in a new manner. Variables and the association of variables with values, partial evaluation, formal parameters etc. belong to these mechanisms.

Template objects are defined. Like normal objects in the object-oriented programming, these template objects have a state defined by the allocation of their variables and a “behavior” influenced by this allocation.

However, in contrast to normal objects, in template objects variables can also (still) be unallocated [template currying], thereby they behave like the parameters of procedures. The unallocated (free) variables are parameters of the template. A template object “knows” which ones of its parameters are free and which ones are associated. Only free parameters can be influenced externally.

For maximum flexibility, as many [all] parameters as possible should be kept free. The template currying as well as defaults allow for this without allowing the complexity for the end user to become impossible.

A template object becomes only complete by the combination with an allocation of all of its free variables. An allocation is an association of variable (names) with values. By these, the free parameter variables of a template are associated with specific values. Once associated, they are no longer available as parameters.

Template objects can also be combined with incomplete allocations, thus with such ones, in which not all of the free variables of the template object are associated with a value. From this combination of template+associations a new template object with the now still remaining free variables as parameters results. Therein, this new object continues to refer to its constituents.

By this mechanism, templates can be exactly tailored to particular applications: the template configurator allocates all of the parameters except for those, which are to be alterable by the end user. [This point is of central importance.]

So-called default allocations can be defined. These associate values with parameter variables like normal allocations, however, the thus associated variables continue to be available for associations. Therein, newer associations have priority over old associations.

Associations can also in turn contain templates as values, these templates then are “sub-templates” of the template with which they are associated. Thereby, a hierarchy of templates can be constructed.

The unassociated parameters of all of the secondary templates are associated with the template involving them. The possibly complex sub-structure of a template thus normally remains hidden, but can be made visible by appropriate tools (tools for template producers). [Abstraction]

Instead of a specific value, a variable can also be associated with another variable. Thereby, its value depends on the value of this other variable.

A special kind of the dependent association is the structural inheritance. Therein, the value of a parameter variable is not associated with a specific other variable, but the value of a variable with the same name of a primary template is taken.

In structural inheritance, it can happen that by this mechanism no value is associated with a free variable. Therefore, first a default value should be defined.

Structural inheritance can also be defined otherwise: as dependent association with plural outputs (thus push versus pull). Thereby, undefined states are avoided. The value of a variable can also be associated with any procedure calculating this value. (This results from (a) the fact that procedures are a special case of templates, and (b) values can also be templates. Further it results, that possibly parameters of the procedure again fit in the template/association systematic).

Relations between variables can also be defined. By these, valid variable associations can be calculated by the system, or it is determined that there is no valid allocation. These relations can e.g. be arithmetical, logical, contain inequalities, etc. Dependent associations are e.g. only a special case of relations.

By refinement, new templates with additional behavior and additional free variables (and/or association of certain existing free variables) can be generated from templates.

From concrete objects (again) templates can be generated by replacing fixed attributes/objects by a parameter variable (therein the current value usually is taken as default). This is possible for both sub-objects and attributes.

In order that data from unstructured file formats can be incorporated into the template concept, structures have to be detected automatically or assisted.

Kernel

The kernel allows, together with the associated template technology, to divide the complexity of problem definitions in producing publication documents, and to treat parts separated from each other. The separation into the design objects and the processing thereof is here of great importance. The design objects are completely described by their respective templates and can be processed and evaluated via the kernel, respectively.

The templates are available for the different design variants for controlled variant modification. Through the described parameter association, it is only restricted to the allowed “wanted” design variations. As additional information, further design rules can automatically generate “wanted” design variants. All of the design variants are in the form of templates as electronic representation on a digital storage medium and can be processed, varied, duplicated and converted as a direct electronic pattern for succeeding processes via the kernel. Appropriate formats for succeeding processes currently are e.g. EPS, TIFF, PDF, SVG, HTML and XML, however, there is no restriction to this exemplary selection.

The kernel represents a continuously extendable virtual machine for processing templates to template variants, thus derived templates. Here, extendable means that the kernel can grow in its mightiness in any manner according to the requirements. Only the kernel contains the knowledge about how the templates and the rules contained therein are to be executed and translated, respectively. Thus, it is the central device for producing and processing templates.

Method for Producing Templates and Template Variants

The method for producing templates is preferably based on a computer program and can be executed on both a local and a remote computer. The execution can be telecontrolled by a natural person or by another computer program. Therein, the telecontrolled method of producing and processing currently uses standard technologies such as Internet, Intranet and World Wide Web or WAP, but is not limited thereto.

The Production of Templates Occurs in the Following Phases:

(a) Reading-in logically unstructured, but graphically structured printing patterns in formats ready for printing

(b) logically detecting and analyzing graphical structural features within the printing pattern

(c) producing a logical component structure from the graphical structural features

(d) associating these logical components to substitution elements parameterizable in any manner (parameterizable in any manner=maximal freedom)

(e) simplifying the substitution elements by determining parameters

dividing the parameters in fixed and variable portions

the division is determined by the user, not by the program structure

(f) producing a parameterized pattern (template) from:

the original pattern of its component structure (via structural features)

the substitution elements of its fixed and variable parameters

the defaults for the variable parameters

the access between substitution elements and components of the printing pattern

Method for Producing Design Variants from Templates

The method for producing design variants is also preferably based on a computer program, which can be executed on a local and a remote computer. The execution can be telecontrolled by a natural person or by another computer program.

The Production of Design Variants Occurs in the Following Phases:

(g) Automatic production of forms from the parameterized printing pattern through the evaluation of the templates

(h) Automatic production of a preview from the printing pattern with the current values of the variable parameters (optional)

(i) Substitution of the variable parameters of the parameterized printing pattern by filling-in the form or by values generated by a computer program

(j) Adaptation of the printing pattern to the current parameter state of the substitution elements

(k) Storing the thus generated design variant as a template with contained parameterized printable pattern on a digital storage medium such as hard disk, CD ROM, DVD etc.

Other objects, features and advantages of the present invention will be understood by reference to and understanding of the following description with reference to the attached drawings.

### BRIEF DESCRIPTION OF THE DRAWINGS

By the following embodiments in conjunction with the drawings, the importance and the advantages of the invention are further clarified, wherein

FIG. 1 shows a flow diagram for explaining the phases for producing a template according to an embodiment of the present invention;

FIG. 2 shows a flow diagram for explaining the method steps for producing a design variant via the Internet according to an embodiment of the present invention;

FIG. 3 shows a schematic representation of a template according to an embodiment of the present invention;

FIG. 4 shows a schematic representation of a finished design variant as a parameterized printable pattern; and

FIG. 5 is a schematic representation of a preferred hardware configuration according to the invention.

### DETAILED DESCRIPTION OF AN EMBODIMENT

The invention is explained in detail below with reference to the drawings. First, the used terms are defined more detailed:

A logically unstructured printing pattern designates a document retained on a storage medium in electronic form, which has been produced and graphically structured with a standard publishing program. The unstructured printing pattern contains all of the electronically encoded information required for visualization of the underlying document. There is no systematic division of logical visualization components such as text columns, titles, pictures, logos etc., of which the document is composed. Rather, in representation of unstructured printing patterns the pixels are driven individually.

From graphical structural features, logical visualization components are derived from encoded visualization methods through their underlying program code.

A component structure designates a systematic division of the logical visualization components such as text columns, titles, pictures, logos etc. of which the document is composed.

Parameterizable substitution elements designate logical visualization components such as text columns, titles, pictures, logos etc., which can be altered in content and form by free or limited ranges of parameter values by e.g. external program-controlled intervention.

A parameterized pattern (template) designates a structured pattern, which, retained on a storage medium in electronic form, in addition to his printable pattern, contains its referring systematic division of the logical visualization components such as text columns, titles, pictures, logos etc. The printable pattern is also retained on a storage medium in electronic form in a known standard format such as EPS, TIFF, PDF, SVG, HTML and XML. Therein, the storage location of the printable pattern does not necessarily have to correspond to the storage location of the associated template. It is sufficient if a reference is in the template, such as a URL usual in Internet, through which the exact storage location can be localized via the Internet.

A design variant designates a parameterized pattern (template), which has been altered in content and form e.g. by external program-controlled intervention, and retains all of the components including the printable pattern in a data package (bundle) on an electronic memory.

Each finished design variant designates a template derived by the invention based on the unstructured pattern, wherein from each template any number of design variants can be produced. Preferably, this one is in electronic form and serves e.g. as an advertising means such as advertisements of every kind, brochures, magazines, but also so-called job printings such as: sheets of letter, calling cards, congratulations cards, cards announcing somebody's death. Apart from the classic printings, personalized publication documents increasingly get importance. These are especially suited to the output, directly achievable on electronic way, to digital printers, CTP systems and display screens via the Internet.

A finished design variant can be delivered to the customer as a shop product. A shop product additionally can contain further information such as price indications for particular quantities.

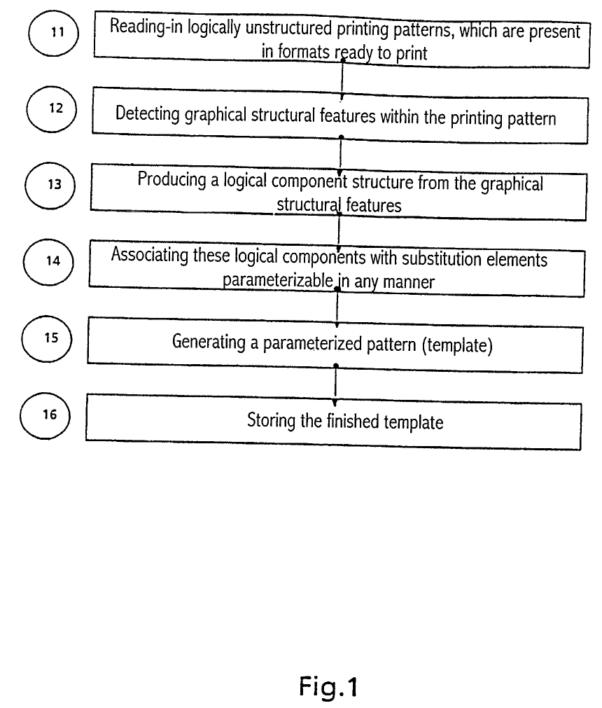

FIG. 1 schematically shows the essential steps for producing a template according to the invention by the designer or template producer. In the first step 11, a logically unstructured printing pattern is read into the inventive computer program MetaAd Creator for producing templates. This unstructured printing pattern has been produced with e.g. a standard program and exists in a format ready to print such as EPS, PS, PDF, SVG etc., and then is analyzed and inspected for graphical structural features by the computer program MetaAd Creator according to the invention in method step 12. In 13, from the found essential structural features a logical component structure is constructed. The component structure optionally comprises fixed and/or variable logical components.

Parameterizable substitution elements matching the variable components are displayed for the designer or template producer as associated parameter names via the user interface in MetaAd Creator. In step 14, the association of the respectively interesting variable components to substitution elements parameterizable in any manner is effected. The parameters can be restricted in their range of values to a repertoire of values by the designer or template producer. E.g., a certain color palette or a defined group of advertising texts can be associated as substitution elements. However, sometimes it is useful not to restrict the repertoire of values. An example for this is, if future users are to get the possibility to be able to replace text components by any own texts. In step 15, the parameterized printing or design pattern (template) is produced, which contains all the variable and substitution components and/or rules, respectively. After storage on a digital data carrier such as a hard disk, this design pattern is designated as a MetaAd template and is immediately available as a pattern for producing any number of formation or design variants. In addition, an appropriate archival system can be connected program-controlled through an interface configurable in any manner for archiving. Herein, MetaAd templates, design variants and also substitution elements could be archived and managed.

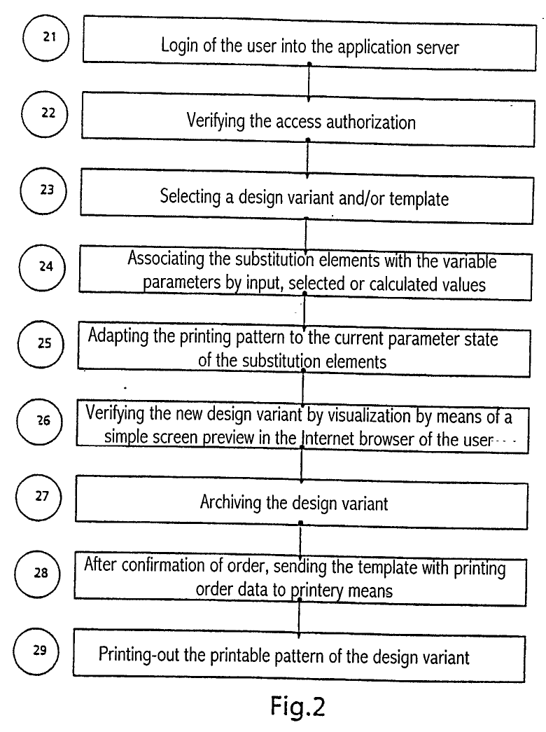

FIG. 2 schematically shows the essential steps for producing a design variant according to the invention by the customer or user. In the first step 21, the login of the customer or user is effected. Subsequently, in 22 his authorization is effected by verifying an individual password by the computer program MetaAd Web Deploy according to the invention. After acknowledgement of his access authorization, he is allowed to process his MetaAd templates by MetaAd Web Deploy in telecontrolled manner. In step 23, a design variant or template, respectively, is selected by the customer or user. In step 24, by association of the substitution elements with the variable parameters or components, respectively, design variants of the MetaAd templates are produced. Therein, design variants designate all of the MetaAd templates, which resulted in this manner from the original template originally produced by the designer or template producer.

The original template is identical in structure, but is not written-over by the effected alterations. In the substitution elements, e.g. pictures or text elements of a fixedly preset range of values can be replaced by customer or user selection. However, the range of values for substitution elements does not necessarily have to be restricted, but can also be opened for unrestricted alteration of parameter values by the producer or designer. For example, this can be useful, if for texts the free text input or the association of colors with texts or geometries is to be allowed.

Further, the substitution elements can be provided as results of program calls. In this case, the module MetaAd Batch Deploy is used for automatic parameter association by program-generated values. By MetaAd Batch Deploy, also the entire customer or user dialog can be dropped, and all of the design variants can be determined by the program-controlled provision of substitution elements.

In step 25, the printing patterns embedded in the MetaAd template are adapted to the current parameter state of the substitution elements. Hereby, the temporary design variant is finished. If needed, in step 26, a preview picture for verification is generated, which is sent to the web browser of the customer or user for visualization of the design variant. Hereby, an interactive operation with immediate control by the visualization of all of the effected alterations of content and design in a design variant or of the respective MetaAd original template is allowed.

In step 27, this design variant is stored for archiving in the customer or user directory for these design variants. An appropriate archival system can also be connected program-controlled through an interface configurable in any manner for archiving. Herein, MetaAd templates, design variants and also substitution elements can be archived and managed.

In step 28, optionally an ordering procedure is initiated. Here, the customer has the possibility of starting a basket function or other buying or paying operations and of placing a printing order. After input of the printing order data and sending the confirmation of order, through the MetaAd template a printing order is generated in a printery means. The printing order data can also be contained in the MetaAd template. The complete execution of the thus placed printing order including payment can be effected via MetaAd Web Deploy.

In step 29, the printable pattern is printed from the design variant with accounting for the printing order data.

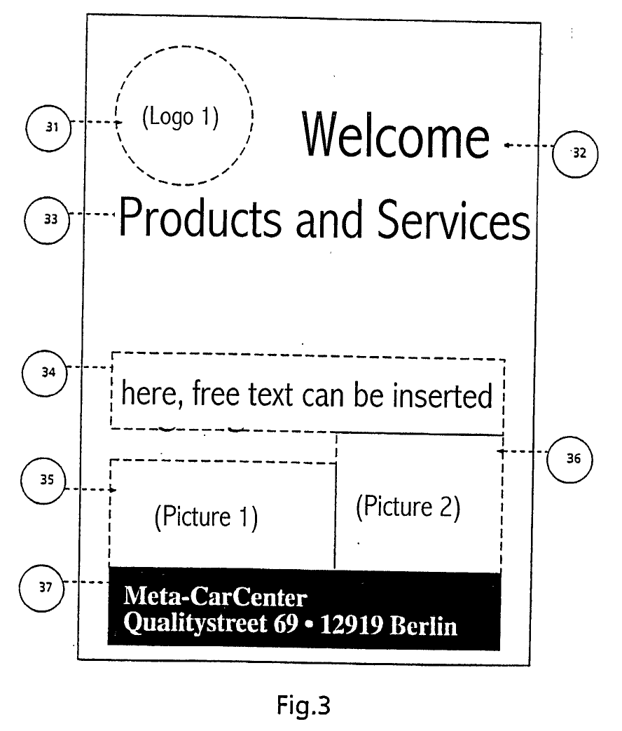

FIG. 3 shows a MetaAd template with fixed or static and variable or dynamic visualization components, respectively, wherein the dynamic visualization components in the MetaAd Creator are associated with parameters as default values, which are then replaced by substitution elements at a later point in time. This replacing procedure occurs on the MetaAd template by the application of the inventive programs MetaAd Web Deploy, MetaAd Batch Deploy, MetaAd GUI Deploy or even again MetaAd Creator.

In 31, the logo 1 can be replaced e.g. by other logos, which are possible as substitution elements. The static visualization components 32 and 33 are fixedly associated with parameters and are not enabled for later replacement.

By 34 and 37, it is to be displayed that via a MetaAd application a replacement by any text can be effected. The font selection and the font size are fixedly preset in this example, and only a content alteration can be effected. However, by further free parameters for this substitution element e.g. the font color, type, size etc. could here also be kept variable.

The components 35 and 36 are dynamic visualization components of the picture type. Also here, first, default values are associated with the free parameters, which can then be replaced by a MetaAd application.

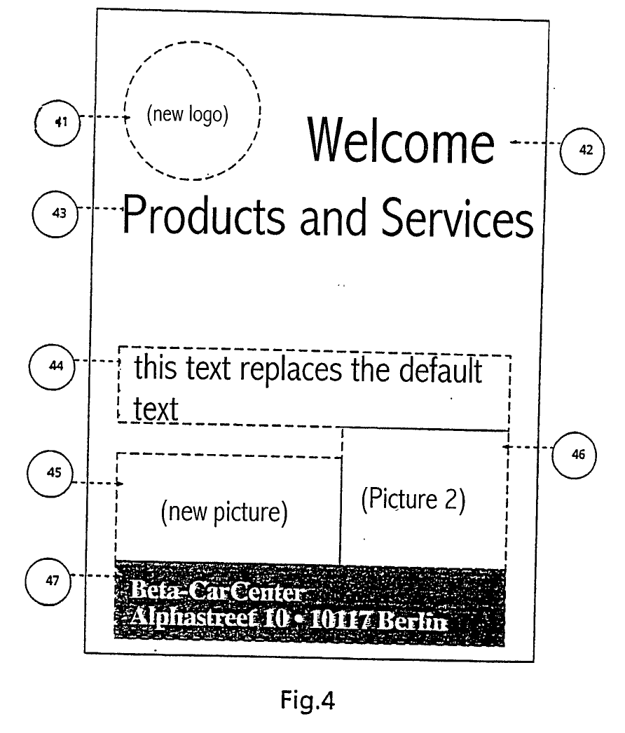

FIG. 4 shows a design variant which is identical in structure to the MetaAd original template of FIG. 3. In this figure, it is essential, that it represents a concrete design variant, which resulted from the replacement mechanism of a MetaAd application on a MetaAd original template.

The logo 1 of the parameter of 31 associated as default value has been replaced by another logo 41. In 42 and 43, no alteration could be effected. By 44 and 47, it is shown that the free parameters of FIG. 3 have been replaced by new texts.

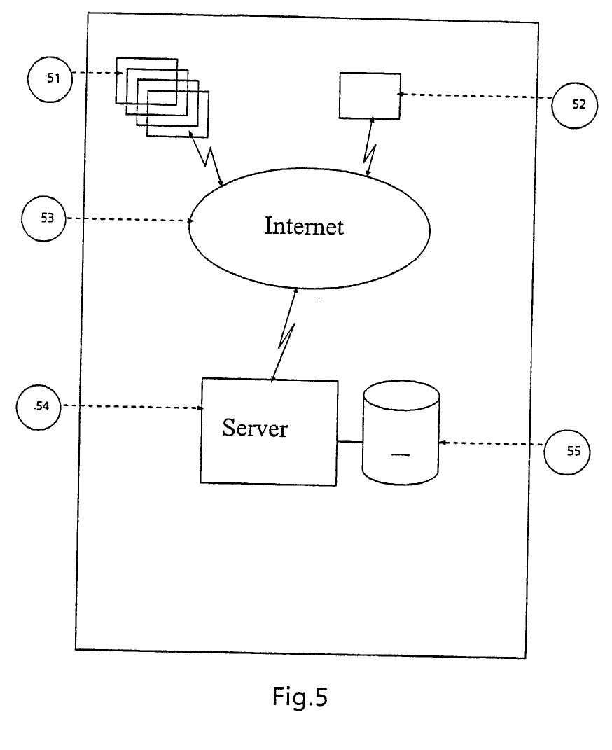

FIG. 5 shows a preferred hardware configuration for carrying out the invention. Reference symbol 51 designates customers or users, which generate e.g. design variants of present templates on a central server by means of client computer in a standard web browser via the Internet or Intranet. The method steps for generating design variants have been explained with reference to FIG. 2.

Reference symbol 52 designates one or more designers or template producers, which produce templates on their local computer and transmit them to a central server via the Internet or Intranet. However, they can produce them also by means of client computers in a standard web browser directly via the Internet or Intranet.

Reference symbol 53 designates the connection between customer, user, designer or template producer and application server via the Internet or Intranet.

Reference symbol 54 designates the application server on which the web application effects the execution of the instructions of the customers, users and designers or template producers, as was explained with reference to FIG. 2. The printing patterns, substitution elements etc. are provided in an appropriate data retention 55. The hardware configuration is not fixed to a certain type of computer.

Those skilled in the art will appreciate that modifications to the exemplary embodiments of the present invention are possible without departing from the spirit and scope of the present invention. Accordingly, the foregoing description of the exemplary embodiments is provided for the purpose of illustrating principles of the present invention and not in limitation thereof, since the spirit and scope of the present invention is ultimately defined by the claims.

1. Method for producing variable printing patterns, comprising the steps of:
providing a logically unstructured and graphically structured basic printing pattern present in the form of a program code,
detecting at least one graphical structural feature of the basic printing pattern,
producing at least one logical component based on the at least one graphical structural feature, and
producing a variable printing pattern by using the at least one logical component.

2. Method according to claim 1, wherein the at least one graphical structural feature is the graphical representation of a logical component as that of a word, a title, a text column, a picture or the like.

3. Method according to claim 2, wherein the logical component is replaced by a substitution element, which is generated individually or is selectable from a plurality.

4. Method according to claim 3, wherein the substitution element itself is a parameterized or a non-parameterized printing pattern.

5. Method according to claim 1, wherein the at least one logical component is parameterized by linking the graphic underlying the at least one structural feature to at least one function.

6. Method according to claim 5, wherein the parameterized logical component has a parameter for a format allocation, color allocation and/or rule linkage.

7. Method according to claim 6, wherein the rule linkage is a functional linkage to a database.

8. Method according to claim 1, wherein the basic pattern is a printing pattern produced by a standard publishing program.

9. Method for varying or completing a printing pattern, comprising the steps of:
providing a logically unstructured and graphically structured basic printing pattern present in the form of a program code,
detecting at least one graphical structural feature of the basic printing pattern,
producing at least one logical component based on the at least one graphical structural feature,
producing a variable printing pattern by using the at least one logical component,
providing the variable printing pattern on an application server in a data network, preferably the Internet,
enabling a user to access the application server, especially with verification of an access authorization, and
associating substitution elements with parameterized components by a user or client.

10. Device for producing variable printing patterns comprising
an analyzing means for detecting at least one graphical structural feature of a logically unstructured and graphically structured basic printing pattern present in the form of a program code,
a synthesizing means for producing at least one logical component based on the at least one graphical structural feature, and
an editor means for producing a variable printing pattern by using the at least one logical component.

11. Device according to claim 10, wherein the at least one graphical structural feature is the graphical representation of a logical component as that of a word, a title, a text column, a picture or the like.

12. Device according to claim 11, wherein the component is replaceable by a substitution element, which is generated individually or is selectable from a plurality.

13. Device according to claim 12, wherein the substitution element itself is a parameterized or a non-parameterized printing pattern.

14. Device according to claim 10, wherein the at least one logical component is parameterizable in the synthesizing means by linking the graphic underlying the at least one structural feature to at least one function.

15. Device according to claim 14, wherein the parameterized logical component has a parameter for a format allocation, color allocation and/or rule linkage.

16. Device according to claim 15, wherein the rule linkage is a functional linkage to a database.

17. Device according to claim 10, wherein the basic pattern is a printing pattern produced by a standard publishing means.

18. Device of claim 10, used in combination with:
an application server means for providing the printing pattern in a data network,
a client means for enabling the login of a user into the application server, especially with verification of an access authorization, wherein
substitution elements can be associated with parameterized logical components by a user or client from the client means.

19. Computer readable medium containing a computer program product for producing variable printing patterns, the computer program product comprising:
program instructions that provide a logically unstructured and graphically structured basic printing pattern,
program instructions that detect at least one graphical structural feature of the basic printing pattern,
program instructions that produce at least one logical component based on the at least one graphical structural feature, and
program instructions that produce a variable printing pattern by using the at least one logical component.

20. The computer readable medium of claim 19, wherein the computer program product further comprises:
program instructions that provide the printing pattern on an application server in a data network,
program instructions that enable a user to access the application server, especially with verification of an access authorization, and
program instructions that associate substitution elements with parameterized components by a user or client.
